(19) United States
(12) Patent Application Publication
(10) Pub. No.: US 2010/0205198 A1
(43) Pub. Date: Aug. 12, 2010

(54) SEARCH QUERY DISAMBIGUATION

(76) Inventors: Gilad Mishne, Oakland, CA (US); Raymond Stata, Atherton, CA (US); Fuchun Peng, Sunnyvale, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/367,114

(22) Filed: Feb. 6, 2009

(51) Int. Cl. G06F 17/30

(52) U.S. Cl. 707/759; 707/E17.014; 707/713

(57) ABSTRACT

Disclosed herein is a system and method of query disambiguation. At least one model is generated using training data, which model can be used to score, or rank, possible interpretations identified for a query, which can be used to select an interpretation from a number of possible interpretations. A selected interpretation can be used to process a web search request, e.g., to generate search results that relate to the selected query interpretation, rank or order the items in the search result based on relevance to the selected query interpretation, and/or identify a presentation to be used to display the search results based on the selected query interpretation.

### FIELD OF THE DISCLOSURE

The present disclosure relates to processing web search requests, and more particularly to training one or more models for use in processing web search queries and disambiguation of web search queries.

### BACKGROUND

Information retrieval, such as that performed in a web search, retrieves items of information, e.g., documents, using search criteria, e.g., criteria contained in a search query, which comprises one or more search terms to compare to candidate items of information. In a web search, each item of information, or document, is typically identified by a uniform resource locator (URL), and each document retrieved is considered to have some relevance to the query, or criteria contained in the query. A search can generate a score for some or all of the documents being considered in the search, and the score can be used to determine whether or not a document is relevant and/or included in a set of search results generated for the query. A document's score can be used as a degree of relevance of the document to the query relative to other documents retrieved, and can be used to rank, or order, the retrieved documents in the set of search results based on relevance.

A document's score can be based on a number of factors, or features. By way of some non-limiting examples of features, a document's score can be based on a number of the query terms, or phrases, contained in the document; a number of occurrences of a query term/phrase in the document; location or placement, such as without limitation title, body, etc., of a query term in the document; etc. A document's score can be generated using various techniques. One such technique involves a model, which is trained using a machine-learning approach. The model comprises query document pairs, and features for each query document pair used to train the model. The trained model can be used to generate a score for a document retrieved using a query based on features associated with the document and query.

### SUMMARY

Documents identified in a set of search results for a query can be based on, or influenced by, an interpretation, or meaning, given to a query as a whole, or some portion of the query. Terms used in the query, and/or the query as a whole, can be ambiguous, e.g., can be subject to more than one interpretation or meaning. A typical query contains a few words, which are not necessarily in order, and completely lacks, or has very little, grammatical structure, both of which can lead to ambiguity and/or an erroneous interpretation. An error in interpretation of a query or a query term can have a significant impact on the relevance of search results generated for the query. It is therefore beneficial to be able to interpret a query, or query term, accurately.

The present disclosure seeks to address failings in the art, such as those discussed above, and to provide a system and method of query disambiguation. In accordance with one or more embodiments, one or more interpretations of a query are generated, each interpretation comprises: 1) a partition of the query into one or more word spans, each span having one or more words, or terms, of the query, which spans are also referred to herein as entities, each span having at least one attribute, e.g., entity type, confidence score, etc., and 2) one or more attributes associated with the collection of spans, such as confidence score, interpretation type, etc. It should be apparent that an interpretation can comprise additional/other information. In accordance with one or more embodiments, a span is non-overlapping, such that a term in the query is assigned to one span, e.g., a term is not shared across spans. An interpretation is selected from the one or more interpretations of the query using the interpretations' confidence scores.

In accordance with at least one embodiment, a model is used to generate confidence scores. In accordance with one or more such embodiments, the model is generated using training data. The model can comprise a model used to score an interpretation using features of the interpretation. Alternatively, the model can comprise a model used to rank more than one interpretation, e.g., two interpretations, using features of each of the interpretations being ranked. In accordance with one or more such embodiments, an interpretation can comprise one or more entities, each of which comprises one or more terms, or words, of the query, and an entity type for each entity. In accordance with one or more embodiments, an interpretation can be selected from a number of identified interpretations using the confidence scores generated for the identified interpretations. A selected interpretation can be used to process a web search request, e.g., to generate search results that relate to the selected query interpretation, rank or order the items in the search result based on relevance to the selected query interpretation, and/or identify a presentation to be used to display the search results based on the selected query interpretation.

In accordance with one or more embodiments, a query interpretation model can be generated from training data. The training data can be collected from input received from human judges to train a query interpretation model to score query interpretations. Alternatively, training data can be generated using a training data generation tool and used to train a query interpretation model to rank query interpretations based on a comparison of the query interpretations.

In accordance with one or more embodiments, a number rewriter can be used to disambiguate numeric terms used in a query. By way of some non-limiting examples, the number rewriter can be used to identify equivalents for a numeric term used in the query, a phrase in a query that includes a numeric term, a numeric term and associated unit of measurement of the query, and to generate equivalents for a number-only query.

In accordance with one or more embodiments, a method is provided, which receives a query in a web search request, identifies a plurality of interpretations of the received query, each interpretation comprising at least one confidence score, and one of the plurality of interpretations of the query is selected for use in a web search using the at least one confidence score of each of the plurality of interpretations.

In accordance with one or more embodiments, a system is provided, which comprises at least one server configured to receive a query in a web search request, identify a plurality of interpretations of the received query, each interpretation comprising at least one confidence score, and select one of the plurality of interpretations of the query for use in a web search using the at least one confidence score of each of the plurality of interpretations.

In accordance with one or more embodiments, a computer-readable medium is provided, which tangibly stores program code, the program code comprising code to receive a query in a web search request, code to identify a plurality of interpretations of the received query, each interpretation comprising at least one confidence score, and code to select one of the plurality of interpretations of the query for use in a web search using the at least one confidence score of each of the plurality of interpretations.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an exemplary component overview in accordance with one or more embodiments of the present disclosure.

FIG. 2 provides an exemplary scorer component overview in accordance with one or more embodiments of the present disclosure.

FIG. 3 provides an example of components used to generate training data to train an interpretation scorer in accordance with one or more embodiments of the present disclosure.

FIG. 4 provides an example of components used to generate an interpretation scorer in accordance with one or more embodiments of the present disclosure.

FIG. 5 provides an example of query interpretation process flow for use in accordance with one or more embodiments of the present disclosure.

FIG. 6, which comprises FIG. 6A and 6B, provides a training data generation process flow in accordance with one or more embodiments of the present disclosure.

FIG. 7 illustrates some components that can be used in connection with one or more embodiments of the present disclosure.

### DETAILED DESCRIPTION

In general, the present disclosure provides machine leaning in search query disambiguation, and a system, method and architecture therefor.

Certain embodiments of the present disclosure will now be discussed with reference to the aforementioned figures, wherein like reference numerals refer to like components.

In accordance with one or more embodiments, a scorer is provided for use in an information retrieval system, e.g., a web search system or engine, to generate scores for query interpretation(s). In accordance with one or more embodiments, a generated score represents a confidence score, e.g., a likelihood that an interpretation is an intended interpretation. In accordance with one or more embodiments, the scorer is trained using training data, which can be provided by human judges and/or generated by a training data generator. In accordance with one or more embodiments, the training data generator is trained using training data. In accordance with one or more embodiments, a number rewriter is provided to identify equivalents for numeric terms used in a query. In accordance with one or more such embodiments, the number rewriter can be trained.

While a query maybe capable of being interpreted a number of ways, it usually has an intended meaning, or interpretation. If the query is misinterpreted, the search results of the query will likely be irrelevant to the query. By way of a non-limiting example, a query containing the words, or terms, “new york pizza Sunnyvale” has a number of interpretations. One interpretation, the likely interpretation, can be expressed as follows:

[new york pizza]/food [sunnyvale]/location

In the above exemplary expression, terms inside a set of brackets, “[” “]”, are grouped together in a single span, and are collectively referred to as an entity. The word or words following the forward slash, “/”, identifies a type for the entity, and is referred to herein as an entity type. The expression represents one interpretation of the query, which indicates an intent to search for new-york-style pizza in the Sunnyvale, Calif. area.

Another interpretation of the query can be expressed as follows:

[new york]/location [pizza]/food [sunnyvale]/location

These are just a few examples of some interpretations that exist for one query example. It should be apparent that any syntax can be used to express an interpretation. Furthermore, additional information, e.g., a confidence score, can be included in an expression. A query, such as that shown above, typically contains a minimal number of terms and lacks grammatical correctness. A term, or terms, appearing in a web query may have a number of different meanings, or interpretations. Accuracy of search results, and improved presentation search results, can be achieved by identifying the most likely interpretation.

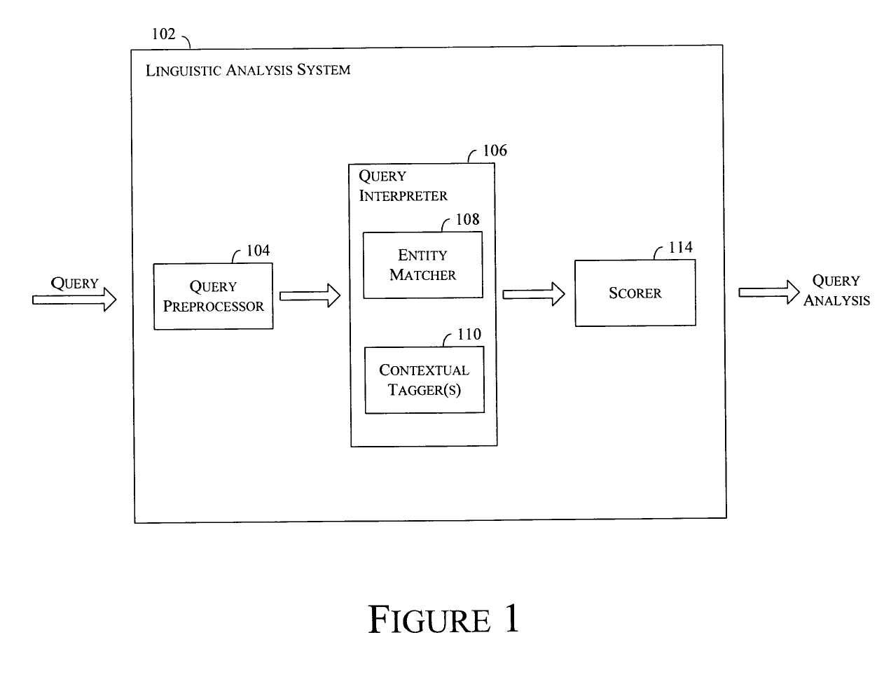

FIG. 1 provides an exemplary component overview in accordance with one or more embodiments of the present disclosure. In the example shown in FIG. 1, linguistic analysis system 102 includes a query preprocessor 104, query interpreter 106 and a scorer 114. A query is received by linguistic analysis system 102. Other information, e.g., contextual information such as IP address, user location, etc., can also be received by the linguistic analysis system 102 in connection with the query.

Query preprocessor 102 can comprise components configured to, for example, identify the language of the query, and/or perform stemming an abbreviation processing. The output of query preprocessor 104 can be provided to query interpreter 106. Query interpreter 106 generates one or more interpretations of a web search query. Each interpretation comprises at least one word span, e.g., a non-overlapping span of one or more words of the query, each span having at least one attribute, e.g., entity type, confidence score, etc., and at least one attribute associated with the collection of spans, such as confidence score, interpretation type, etc. In accordance with one or more embodiments, at least one type, or category, can be assigned to the interpretation, which can be based on the type(s) assigned to the entity(ies) identified for the query. Given entity types “business” and “location” determined in the example interpretation of the query “new york pizza Sunnyvale” provided above, the interpretation can be considered to fall in a category of interpretations, which indicates that the query is seeking information about a business. Other examples of interpretation types include, without limitation, a request for a review of a business (or businesses), a request for product price comparison information, etc. In accordance with one or more embodiments, an interpretation type can be selected from a set of predetermined interpretation types using the one or more spans and attributes associated with the spans determined for an interpretation.

In accordance with one or more embodiments, words spans are non-overlapping, such that a word in the query is assigned to one word span. In accordance with one or more embodiments, in a case that a word span comprises more than one word, the words in the span have the same sequence as in the query. A word span is also referred to herein as an entity. In accordance with one or more embodiments, each span as one or more attributes, e.g., entity type, confidence score, etc., and each interpretation has an associated feature vector. As is discussed in more detail below, in accordance with one or more embodiments, a feature vector comprises a number of features and an associated value for each feature. In accordance with one or more embodiments, in a case that a feature is not applicable to the interpretation, a value can be assigned to the feature to so indicate.

Query interpreter 106 comprises entity matcher 108 and one or more instances of a contextual tagger 110. Entity matcher 108 identifies entities in the query, e.g., “new york pizza” and “sunnyvale”. By way of a non-limiting example, entity matcher 108 can use a lookup process and one or more resources, e.g., an online dictionary, web pages, documents, etc., to identify possible entities in the query. Contextual tagger 110 identifies an entity type from any defined set of entity types for an entity. Examples of contextual tagger 110 include, without limitation, a tagger, a statistical tagger such as a hidden Markov model (HMM) tagger or a conditional random fields (CRF) tagger. Examples of entity types include, without limitation, product name, location, person name, organization, media, event, etc. A special entity type, token, is used with a word that do not fit into another entity type, e.g., words such as the, what, use, how, do, etc.

Scorer 114 receives output from the query interpreter 106, which output includes the entities identified by entity matcher 108 and the corresponding entity types identified by contextual tagger(s) 110 for each interpretation identified by query interpreter 106, and determines at least one score for the received interpretation. In accordance with at least one embodiment, a score identifies a level of confidence that the at least one query interpretation scored is an accurate interpretation of the query. For each query interpretation identified by query interpreter 106, scorer 114 extracts information and determines values for features based on the extracted information.

In accordance with one or more embodiments, scorer 114 generates a confidence score using a query interpretation model, which is trained in accordance with one or more embodiments of the present disclosure. One or more interpretations, and corresponding scores, are output by linguistic analysis system 102. The output provided by the linguistic analysis system 102 can be used to perform further query analysis. Query analysis can include, without limitation, selecting one of the query interpretations using the confidence score is generated by scorer 114, and using the selected interpretation to perform a search and rank the search results. By way of a further non-limiting example, the selected interpretation can be used to determine how to present the search results, e.g., trigger specialized handling in a user interface by which the search results are displayed, such as displaying advertisements based on a query interpretation selected.

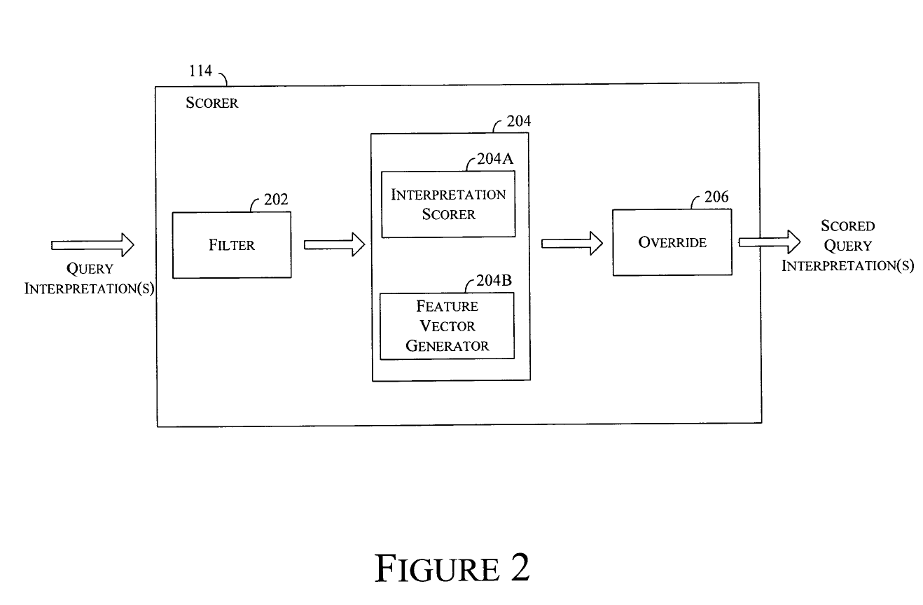

FIG. 2 provides an exemplary scorer component overview in accordance with one or more embodiments of the present disclosure. A scorer, e.g., scorer 114, comprises interpretation scorer and vector generator 204, and optionally includes a filter 202 and override 206. Interpretation scorer and vector generator 204 comprises interpretation scorer 204A and feature vector generator 204B. Filter 202 is configured to apply one or more rules to filter, e.g. remove, interpretations received by scorer 114. Examples of types of filters include, without limitation, regular expression filters and count filters. By way of some further non-limiting examples, a regular expression filter can filter, or otherwise operate on, portions, e.g., a sequence of entity types, of an interpretation using a regular expression, and a count filter can be used to remove an interpretation with more than the number of occurrences of an entity type, a “token” entity type, specified in the count filter. Override 206 can optionally be used to override a score determined by interpretation scorer 204A. By way of a non-limiting example, override 206 can demote a score for an interpretation that includes misspellings.

In accordance with one or more embodiments, feature vector 204B extracts information about features, and generates a feature vector for an interpretation, which feature vector comprises values for features determined for the interpretation. The feature vector is used by interpretation scorer 204A, which comprises one or more machine-learned, or trained, models, to score the interpretation. In accordance with one or more embodiments, a trained model is built using training data, which comprises a set of query interpretations and scores.

In accordance with one or more such embodiments, interpretation scorer 204A can operate in at least two modes. In a scoring mode, interpretation scorer 204A uses a regression model trained using a set of training data that is based on input received from human editors, or judges, to score an interpretation. In the scoring mode, interpretation scorer 204A scores one query interpretation at a time, and determines a score using the values of features in the feature vector generated by feature vector generator 204B for the query interpretation that is being scored. In a ranking mode, interpretation scorer 204A uses a binary classifier to compare two interpretations of a query, and generates a ranking of the two interpretations based on a feature vector that compares each of the features of two interpretations of the query. As is described in more detail below, in a case that interpretation scorer 204A is operating in the ranking mode, the feature vector generated by feature vector generator 204B comprises ratios generated using the feature vectors of two query interpretations being compared. In accordance with at least one embodiment, the ranking model is trained using a first set of training data that is based on input received from judges and a second set of training data that is generated using a training data generation tool.

In accordance with one or more embodiments, a scoring mode model used by interpretation scorer 204A uses training data that is based on input received from the judges. The judges input comprise information that identifies a query interpretation, in a case that the query interpretation is generated by judges, and a score associated with a query interpretation. As discussed above, in accordance with one or more embodiments, an interpretation comprises one or more entities and an entity type for each entity. In accordance with such embodiments, a judge scores one or more interpretations of a query. By way of a non-limiting example, a score can be based on a scale that includes excellent, good, fair and bad scores, as discussed further below. The input received from the one or more judges can collected and used as training data. The training data comprises one or more interpretations for a query, each interpretation comprising one or more entity and entity type pairs, an associated feature vector, and a score.

In accordance with one or more embodiments, training data can be generated using a training data generation tool. The computer-generated training data can be used to train a model used by the interpretation scorer 204A operating in the ranking mode. As is discussed in more detail below, the training data generation tool, also referred to herein as a training data generator, uses training data comprising query interpretations provided by judges for a first set of queries. In accordance with one or more embodiments, the first set of queries is small relative to a second set of queries used to generate training data. In accordance with one or more embodiments, the second set of queries is at least one order of magnitude larger than the first set of queries. By way of a non-limiting example, the first set of queries can comprise 25,000 queries and the second set of queries can comprise 1 million queries. It should be apparent that any number of queries can be used in either training data set. In accordance with at least one embodiment, the first set of queries is minimized, in order to minimize the cost and time associated with using human judges. In accordance with one or more such embodiments, the training data provided by judges in connection with the first set of queries is used to identify an interpretation for each query in the set, e.g., an interpretation for each query that is considered to be the best interpretation, such as an interpretation with the highest, e.g., excellent, score.

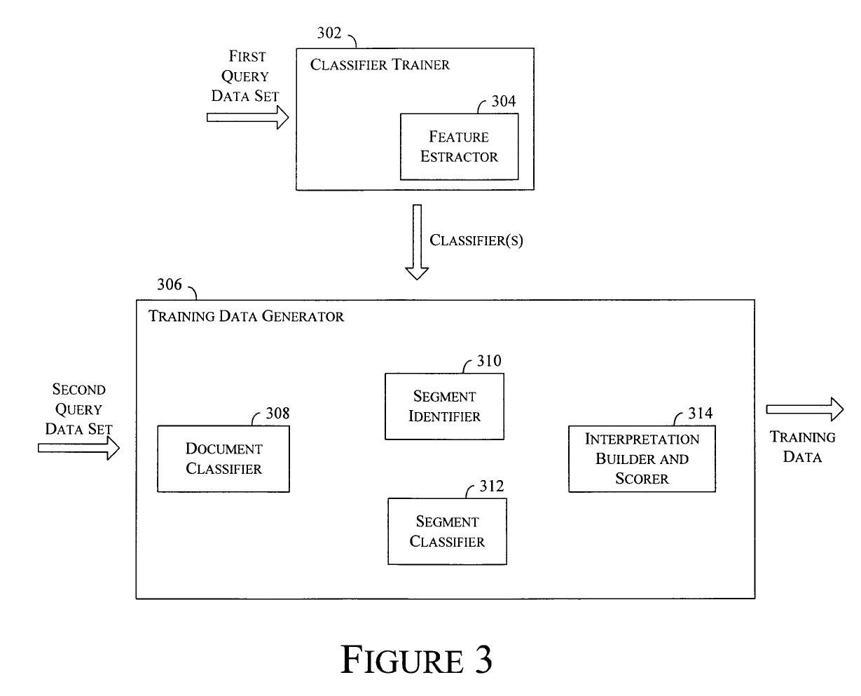

FIG. 3 provides an example of components used to generate training data to train an interpretation scorer in accordance with one or more embodiments of the present disclosure. A first query data set comprises the interpretations generated by judges and search results associated with some or all of the interpreted queries. Each interpretation comprises one or more entities, and each entity has an entity type. In accordance with one or more embodiments, a trainer 302 trains a classifier for each entity type identified by the interpretations in the first training data. For each entity type, search results associated with queries in the first training data that have an interpretation that identifies the entity type are processed by feature extractor 304 to extract features from the documents contained in the search results. In accordance with one or more embodiments, a subset of the queries can be used, e.g., a subset of the top, or most frequent queries. By way of some non-limiting examples, the documents can be examined to identify common words used in the documents, a structure used in an online encyclopedia web page of the entity, etc. A classifier is built by trainer 302 for the entity type, which identifies, for the entity type, features of the documents contained in the search results for the queries that were identified as including entities of the entity type. A classifier can be built for each entity type using the features extracted from the documents contained in the search results for the queries identified as including entities of the entity type. In accordance with one or more embodiments, a classifier can be maximum entropy model, a support vector machine, etc.

A second set of queries, the number of which can be significantly larger than the number of queries used to build the classifiers, are included in second training data, which is used by training data generator 306 to generate training data comprising query interpretations and scores. By way of a non-limiting example, the second set has one million queries. This second set of queries need not be interpreted by judges. The classifiers and the second training data set, which comprises the second set of queries and associated search results, are input to the training data generator 306.

In accordance with one or more embodiments, a document classifier 308 of the training data generator 306 processes one or more documents associated with a query in the second training data set using the classifiers generated by classifier trainer 302. By way of a non-limiting example, classifiers are used to classify the document as being associated with one or more entity types, with each entity type identified having a corresponding confidence score, to indicate a degree of confidence that the document belongs to the entity type. In accordance with one or more embodiments, the document classifier can process a document to extract features of the document, which are then compared to features specified by the classifiers, to select the one or more classifiers, and corresponding one or more entity types, based on a comparison of the features extracted for the document and the features associated with the classifiers. In accordance with one or more embodiments, a confidence score is generated for each entity type identified for a document, which indicates a degree of confidence associated with a classification, i.e., an entity type, identified for the document.

In accordance with one or more embodiments, training data generator 306 comprises a segment identifier 310 and a segment classifier 312, which are used to identify entity and entity type pairs. Segment identifier 310 can be used by the training data generator 306 to identify segments, each segment comprising one or more terms of the query. By way of a non-limiting example, the wording contained in a portion, e.g., a sentence, of the document can be parsed and examined by segment identifier 310 to identify a sequence comprising one or more terms of the query. The portion of the document can be examined by segment classifier 312, which can comprise one or more contextual taggers, to determine a context for the portion of the document containing the query term(s). By way of a non-limiting example, the query term(s) identified in the portion of the documents correspond to an entity, or possible entity, and the determined context corresponds to an entity type, e.g., one of the classifications identified for the document using the document classifier(s). Training data generator 302 comprises an interpretation builder and scorer 314, which converts a lattice, or other data structure identifying combinations, of segments and corresponding segment classification parings into one or more interpretations. In accordance with one or more embodiments, for each query, the training data generator 302 can generate and output at least one interpretation and score pairs, each interpretation comprising an entity and an entity type.

In accordance with one or more embodiments, regardless of the manner in which training data is obtained, e.g., interpretations received from human judges and/or interpretations generated by training data generator 306, the training data comprises a plurality of interpretations, each of which comprises entity and entity type pairings, and a confidence score. The training data can be used to train a model that can be used by the interpretation scorer 204A to score an interpretation. In accordance with one or more embodiments, interpretations received from judges can be used to train a model used by the interpretation scorer 204A operating in a score mode to generate a score for a query interpretation. In accordance with one or more embodiments, training data generated by training data generator 306 can be used to train a model used by the interpretation scorer 204A operating in a ranking mode to rank more than one interpretation of a query.

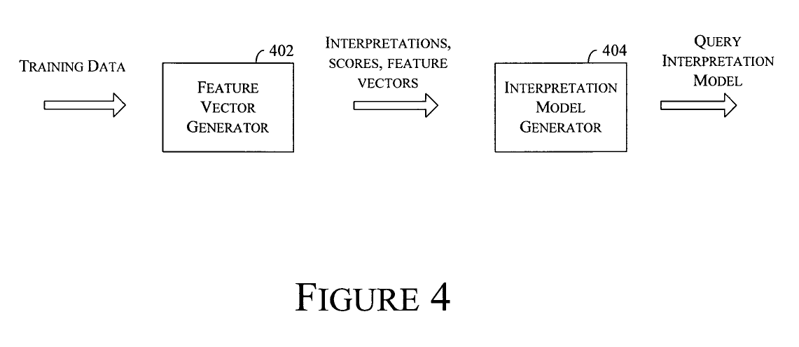

FIG. 4 provides an example of components used to generate an interpretation scorer in accordance with one or more embodiments of the present disclosure. Feature vector generator 402 receives as input training data, e.g., query interpretations and corresponding scores, and generates a feature vector for each of the query interpretations. By way of some non-limiting examples, features can include query-level features, e.g., features associated with a query, such as number of spans, number of words, scores generated by a query spelling preprocessor component, length of query (e.g., in bytes), average unit strength, number of non-token spans, etc., interpretation-level features, e.g., features associated with a query's interpretation, such as a ratio of entities to non-entities (e.g., terms or words used in the query), number of entity types, domain matches, and entity-level features, e.g., features associated with an individual span, or entity, in a query, such as match between clicks and tag type.

In the example shown in FIG. 4, feature vector generator 402 is depicted as a separate component. In accordance with one or more embodiments, feature vector generator 402 can be included with another component, e.g., interpretation builder and scorer 314 of FIG. 3. While a component may be shown separate from another component for ease of explanation, it should be apparent that two or more components can be combined. Conversely, it should be apparent that components shown in combination can be divided into more than one component.

Interpretation model generator 404 generates a model used by interpretation scorer 204A to score an interpretation. In accordance with one or more embodiments, the model comprises a decision tree model, and the interpretation model generator 404 is a decision tree model generator. Interpretation model generator 404 outputs the model, e.g., a score model or a ranking model. By way of a non-limiting example, the decision tree can be a treenet decision tree model, and interpretation model generator 404 can be a treenet model generator.

As discussed above, the query interpreter 106 can identify more than one interpretation of a query. Interpretation scorer 204A can generate a score for each interpretation using a trained model and operating in score mode. In a case that interpretation scorer 204A is operating in a ranking model, interpretation scorer 204A can compare two interpretations of a query, and provide a ranking for the interpretations, which identifies an interpretation as being a better interpretation than the other interpretation. In accordance with one or more such embodiments, in a case that two interpretations are identified, the feature vector generator 402 assigns a value of a feature in the feature vector using a value of the feature determined for each of the interpretations, and generates a new feature value that is to be used with the feature, which is a ratio of the feature values extracted for the interpretations. By way of a non-limiting example, a value of a feature that identifies a number of spans, e.g., the number of entities in the query interpretation, is determined for each of two interpretations, e.g., interpretations A and B, and a new value for the feature is determined as a ratio of the values determined for A divided by the value determined for B.

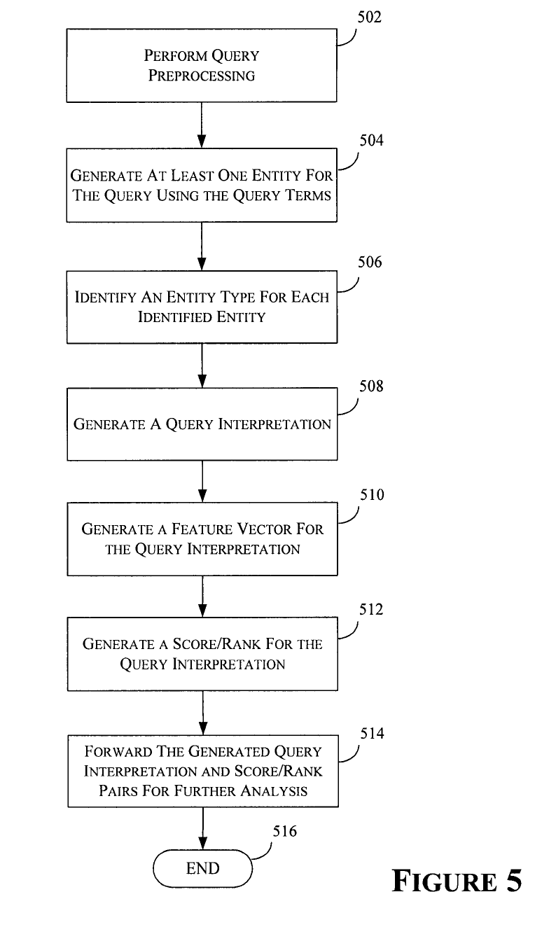

FIG. 5 provides an example of query interpretation process flow for use in accordance with one or more embodiments of the present disclosure. In accordance with one or more embodiments, the process flow is performed by linguistic analysis system 102. At step 502, query preprocessing is optionally performed, e.g., identify a language used in the query, a word misspelling, base or root forms of a word, and/or a meaning of an abbreviation. At step 504, at least one entity for the query is identified from the query terms. By way of a non-limiting example, an entity matching process can be used to identify word combinations in the query using one or more resources, such as an online dictionary or encyclopedia, electronic documents, etc. At step 506, an entity type is identified for each identified entity. By way of a non-limiting example, a statistical tagger can be used. At step 508, a query interpretation is generated from the identified entities and entity types. At step 510, a feature vector is generated for the query interpretation. The features can comprise query-level features, interpretation-level features and/or span-level, e.g., entity and entity type pair-level, features.

At step 512, a confidence score is generated for the query interpretation. In accordance with one or more embodiments, the confidence score comprises a score determined for at least one entity and entity type pair of the interpretation. A confidence score can comprise a score generated from the interpretation's feature vector. Alternatively, the confidence score can comprise a score generated from a feature vector determined from feature vectors from the current interpretation and another interpretation.

Steps 502, 504, 506, 508, 510, and 512 can be performed to identify multiple interpretations of a query. At step 514, the generated query interpretations and corresponding scores/ranks are forwarded for further analysis. By way of a non-limiting example, the query interpretations and scores/ranks are provided to a web search engine, so that a query interpretation can be selected and used to perform a search to retrieve a set of search results relevant to the query interpretation, to rank a set of search results, and/or to identify presentation in which search results are to be displayed.

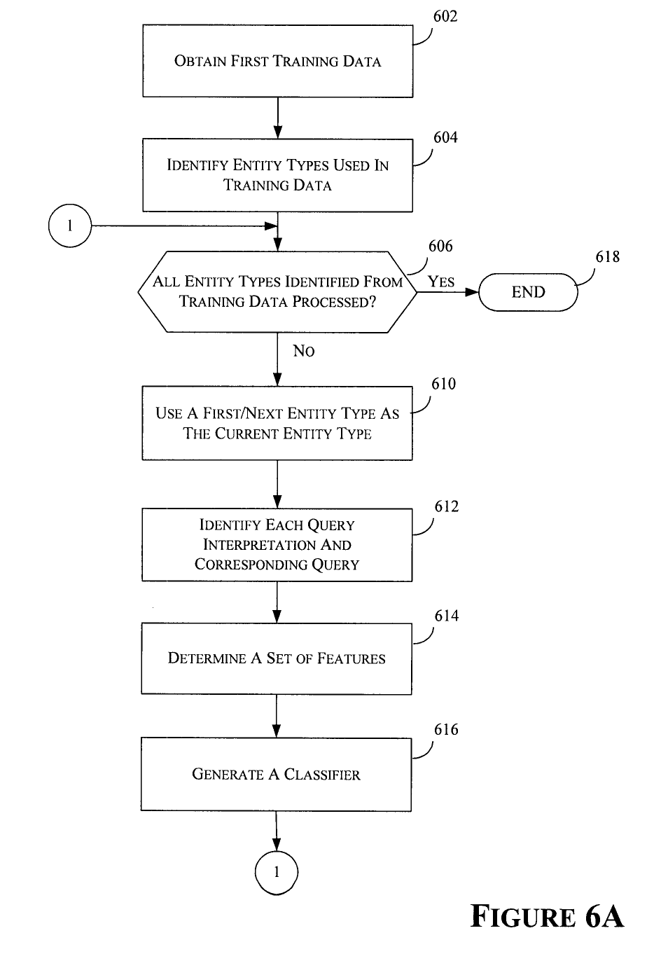

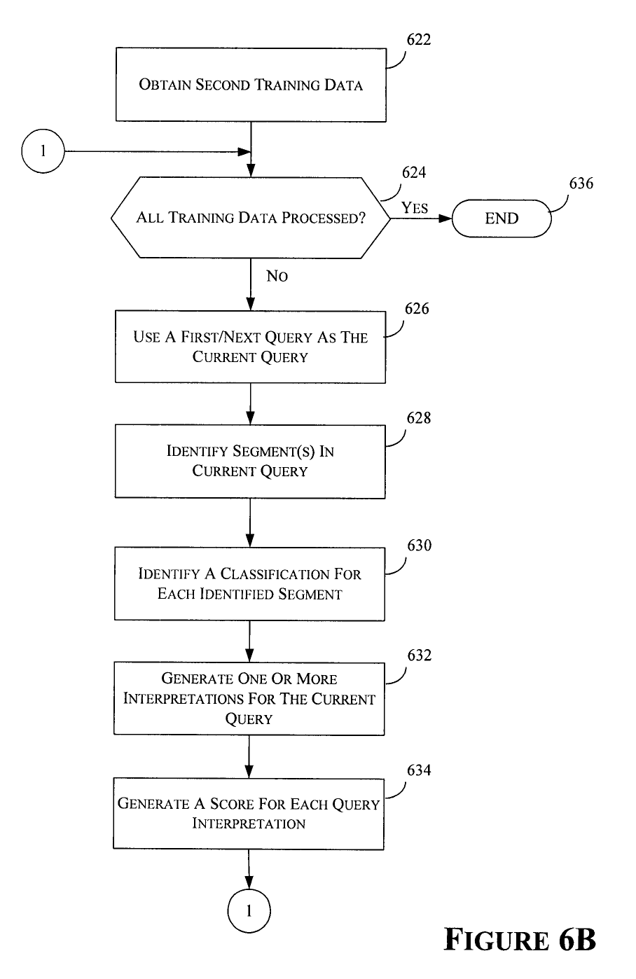

As discussed above, the linguistic analysis system 102, e.g., the interpretation scorer 204A of system 102, uses a trained model to score a query interpretation. In accordance with one or more embodiments, a model is trained using training data generated by a data generator, such as training data generator 306. FIG. 6, which comprises FIGS. 6A and 6B, provides a training data generation process flow in accordance with one or more embodiments of the present disclosure. In accordance with one or more embodiments, the training data generation process flow is implemented by training data generator 306.

As discussed above, first training data, which comprises data collected from input received from one or more judges, is used to train one or more classifiers, which can be used in classifying entities found in queries in second training data. The number of queries in the first training data can be much smaller than the number of queries in the second training data. The first training data comprises interpretations for the queries in the first training data. In accordance with one or more embodiments, the interpretations contained in the first training data represent the “best” interpretations of the queries, based on input received from the judges.

In accordance with one or more embodiments, FIG. 6A provides a classifier generation process flow, which can be implemented by classifier trainer 302. At step 602, the first training data is obtained. At step 604, the query interpretations in the first training data set are examined to identify the entity types specified in the query interpretations. Steps 606, 610, 612, 614 and 616 can be performed for each entity type identified at step 604. At step 606, a determination is made whether or not all of the entity types identified from the first training data have been processed. If so, processing ends at step 618. Otherwise, processing continues at step 610 to use the first, or next, entity type as the current entity type. At step 612, each query interpretation specifying the current entity type, and each corresponding query, is identified. At step 614, some are all of the search results corresponding to each query identified at step 612 are examined to identify features for the classifier. By way of a non-limiting example, a number of the most relevant documents contained in the search results are processed to extract features of the documents.

At step 616, a classifier for the current entity type is generated, which includes the features determined at step 614. Processing continues at step 606, to process any remaining entity types.

In accordance with one or more embodiments, FIG. 6B provides a training data generation processing flow, which can be implemented by training data generator 306. At step 622, the second training data is obtained. At step 624, a determination is made whether all of the second training data has been processed. If so, processing and that step 636. Otherwise, processing continues at step 626, to use the first or next query as the current query. At step 628, one or more segments are identified in the current query. As discussed above, segment identifier 310, identifies segments using one or more resources. At step 630, each identified segment is classified using the classifiers built in accordance with one or more disclosed embodiments. In accordance with one or more embodiments, a lattice, or other data structure, can be built that identifies various segment combinations. At step 632, one or more interpretations of the query can be generated using the identified combinations. In accordance with one or more embodiments, a score can be generated at one or both of steps 626 and 630, which represents a confidence, e.g., a score that represents a level of confidence that the query term, or terms, in the segment are to be used in the segment and/or a score that represents a level of confidence that the segment has the meaning corresponding to the assigned classification. At step 634, a score is generated for each interpretation. In accordance with one or more embodiments, the score is generated using one or both of the segment and segment classification scores corresponding to the segments that form the interpretation. Processing continues at step 624 to process any remaining training data.

An ambiguity can exist with queries that can contain numeric terms. Importance of a numeric term in a query is not diminished by the fact that the bulk of the queries used for searches do not include numeric terms. By way of a non-limiting example, in a query that contains “godfather 2,” “2” is important because it distinguishes from “godfather” and “godfather 3.” Numeric terms, however, may or may not have equivalences. By way of another non-limiting example, “godfather 2” would typically be considered to be an equivalent of “godfather II,” with the one considered to be a match to the other. Generally speaking, numbers typically tend to be attached to some other part of the query. A number that is contained in the query can result in ambiguity. Embodiments of the present disclosure can use a number rewriter component, which can identify numeric equivalents found in a query and/or a document. In accordance with one or more embodiments, a number rewriter can be a component of linguistic analysis system 102. The number rewriter can identify alternative numeric expressions for a numeric term used in a query and/or a document, for example. In accordance with one or more embodiments, some or all of a query can be rewritten to include one or more equivalents in connection with numeric terms found in the query, to include a replacement for a term or terms in the query, and/or to identify a phrase that comprises multiple terms and has an associated “degree of proximity” that is to be enforced for the terms in the phrase.

In accordance with one or more embodiments, the rewriter component can include one or more dictionaries built using training data, which dictionaries can be used by the rewriter component to process a query before a search is performed using the query. Advantageously and by way of a non-limiting example, a query rewritten to include an equivalent for a numeric term using the rewriter component is more likely to locate documents that use the equivalent for a numeric term than the original query.

In accordance with one or more such embodiments, a canonization, or variants, strategy can be used with numeric terms that can have multiple representations, e.g., “2” can be equivalent to other representations of the number including, without limitation, “II”, “two,” “second,” etc. In accordance with one or more such embodiments, a canonization/variant rewrite is context dependent. By way of some non-limiting examples, “3” when used in the context of “godfather 3” is considered to be equivalent to “godfather III,” but “3” when used in the context of “firefox 3” is likely not an equivalent with “firefox III.”

In accordance with one or more embodiments, a machine learning approach can be used with the canonization strategy to identify contexts in which numeric terms are used. A number of queries, e.g., top 10 million queries, are examined to identify whether the query contains a numeric term. If the query contains a numeric term, numeric variants of the numeric term are generated. Equivalent contexts can be determined using a measurement, such as the click profile, i.e., which identifies which items in a set of search results returned for a query were selected by the user. For every variant determined, a determination is made whether the click profile on the variant is similar to the click profile of the original numeric term. In other words, a determination is made whether the same document was selected in connection with queries containing “godfather 2” and “godfather II.” If so, “2” and “II” can be considered to be equivalent when used with the term “godfather,” and a variant can added to a dictionary that contains a list of canonized queries, an entry can indicate that “godfather 2” is a variant of “godfather III”, and vice versa. The list of canonized queries can be compressed to remove redundancies. By way of a non-limiting example, if “godfather 2” is considered to be equivalent to “godfather II,” and the list contains another entry indicating that “godfather 2 memorabilia” is an equivalent as well, the “godfather 2 memorabilia” entry can be removed from the list. In processing a query prior to performing a search, the rewriter component can use the dictionary to identify a subsequence, or sequence of terms, of a query found in the dictionary, an equivalent can be added to the query, together with a “winunit” containing the variant and a context word. For example, the query that contains the subsequence “godfather 2” can be modified to indicate that “II” within “n” words of the word “godfather” also satisfies the query's criteria.

In accordance with one or more embodiments, a proximity boosting strategy can be used with numeric terms that are considered to be a part of a phrase specified in a query. In other words, a numeric term can be considered to be a part of, or separate from, a term or phrase used in the query. By way of a non-limiting example, proximity boosting can be used for segments of queries containing a numeric entity in a case that the entity is recognized as being important in the context of the query. By way of a further non-limiting example, in a query “grammy 2005 winners,” “2005” is considered to be important in the context of the query, and proximity is boosted between “2005” and “winners,” so as to indicate that the two terms are part of a phrase.

In accordance with one or more embodiments, a machine learning approach can be used with a proximity boosting strategy. A dictionary of numeric variants can be built using training data that may identify phrases containing numbers. By way of some non-limiting examples, one or more online encyclopedias can be consulted to identify titles containing numbers, a units web service can be consulted to identify units, e.g., units of measurement, used in connection with a numeric term, and/or some number, e.g., 10 million, of the top queries can be examined to identify queries that start and/or and with a number. A dictionary that includes entries, each of which identifies a phrase, can be built using the training data. If a subsequence contained in a query is found in the dictionary, an indication can be associated with the query to specify that the numeric term used in the subsequence is part of a phrase with one or more terms in the query, and should be proximate to the one or more other terms of the phrase identified in the dictionary. A proximity value can be used to indicate a level with which proximity is enforced in a search using the query. By way of a non-limiting example, a boost parameter can be set as a variable that indicates a degree to which proximity is enforced, e.g. a value of 0.4 can be used.

A query can include a numeric term with a unit specification. In accordance with one or more embodiments, a list of unit types can be maintained, e.g., in a dictionary, and used in examining a query to determine whether or not the query contains a unit specification. By way of some non-limiting examples, a unit can be attached to a number, e.g., “10 mhz,” or it can be unattached, e.g., “10 mhz.” If the query is determined to contain a numeric term with a unit specification, an equivalent with a “winunit” it added to match both the attached and unattached versions. In a case that a unit can have equivalent forms, each equivalent form can be added to the query, and/or a form used in the query can be replace with a more commonly-used form, e.g., “yo” can be replaced with “year old.” For unattached measurements, a proximity boost can be used to indicate that the numeric term and unit term are a phrase.

In some cases, the query can contain only numbers. By way of some non-limiting examples, a query can contain a telephone number, catalog ID, zip code, area code, ISBN, etc. In accordance with one or more embodiments, all the possible joins are considered to be equivalent. By way of a non-limiting example, for a query containing the number, 123-13-44, multiple joins can be used so that 123-1344 and 1231344 would be considered to match. In accordance with one or more embodiments, the order of the numbers used in the query is maintained and each equivalent is processed as a phrase.

In accordance with one or more embodiments, a query that contains two terms one of which is a number can be treated as a numeric phrase even in a case that the phrase is not found in the phrase dictionary discussed above. In accordance with one or more embodiments, a query that contains a year, if it has not already been rewritten as discussed above, can have a proximity boost set for the entire query, to indicate that the year should be close to all of the terms in the query. As discussed above, a proximity boost enforces some degree of proximity with respect to some or all of the terms in the query. A stricter proximity boost can be set for a numeric term that is determined to be a year indication, such that the year is to be considered as part of a phrase including one or more other terms in the query when looking for matches for the query.

In accordance with one or more embodiments, multiple rewrites can occur in the same query and/or for the same term in a query. In accordance with one or more embodiments, information can be retained for a query to identify the rewrites performed for the query. The information can be in the form of an attribute, which can be associated with a query term, or terms, or with the query as a whole. By way of some non-limiting examples, “none” can be used to indicate that no rewrite(s) were performed, “p” can be used to indicate a phrase rewrite, “v” can indicate a variant rewrite, “a” can indicate an “all-numeric” rewrite, and “u” can indicate a unit/measurement rewrite.

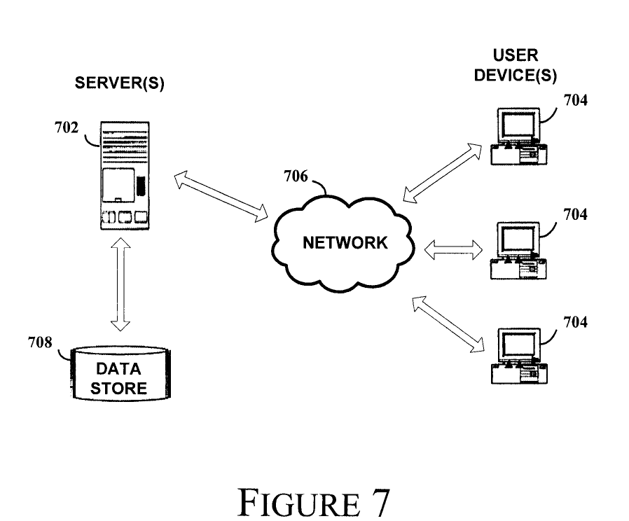

FIG. 7 illustrates some components that can be used in connection with one or more embodiments of the present disclosure. In accordance with one or more embodiments of the present disclosure, one or more computing devices are configured to comprise functionality described herein. For example, one or more servers 702 can be configured to implement any of the components discussed in connection with one or more embodiments of the present disclosure.

Computing device 702 can serve content to user computing devices, e.g., user computers, 704 using a browser application via a network 506. Data store 508, which can comprise one or more data stores, can be used to store data for use in accordance with one or more embodiments, e.g., training data, query log(s) containing queries and search results used as training data, model(s), etc.

The user computer 704 can be any computing device, including without limitation a personal computer, personal digital assistant (PDA), wireless device, cell phone, internet appliance, media player, home theater system, and media center, or the like. For the purposes of this disclosure a computing device, e.g., server 702 or user device 704, includes one or more processors, and memory for storing and executing program code, data and software, and may be provided with an operating system that allows the execution of software applications in order to manipulate data. A computing device such as server 702 and the user computer 704 can include a removable media reader, network interface, display and interface, and one or more input devices, e.g., keyboard, keypad, mouse, etc. and input device interface, for example. One skilled in the art will recognize that server 702 and user computer 704 may be configured in many different ways and implemented using many different combinations of hardware, software, or firmware.

In accordance with one or more embodiments, a server 702 can make a user interface available to a user computer 704 via the network 706. In accordance with one or more embodiments, computing device 702 can make a user interface available to a user computer 704 by communicating a definition of the user interface to the user computer 704 via the network 706. The user interface definition can be specified using any of a number of languages, including without limitation a markup language such as Hypertext Markup Language, scripts, applets and the like. The user interface definition can be processed by an application executing on the user computer 704, such as a browser application, to output the user interface on a display coupled, e.g., a display directly or indirectly connected, to the user computer 704. In accordance with one or more embodiments, a user can use the user interface to input a query that is transmitted to server 702. Server 702 can provide a set of ranked query results to the user via the network and the user interface displayed at the user device 704.

In an embodiment the network 706 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 7. Alternatively, embodiments of the present disclosure can be implemented other environments, e.g., a peer-to-peer environment as one non-limiting example.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving a query in a web search request;
identifying a plurality of interpretations of the received query, each interpretation comprising at least one confidence score;
selecting at least one of the plurality of interpretations of the query for use in a web search, said selecting using the at least one confidence score of each interpretation of the plurality.

2. The method of claim 1, further comprising generating the at least one confidence score for each identified interpretation.

3. The method of claim 2, said generating the at least one confidence score for each identified interpretation further comprising:
determining a plurality of features for the interpretation; and
scoring the interpretation using the plurality of features determined for the interpretation to generate the at least one confidence score for the interpretation.

4. The method of claim 3, wherein a feature of the plurality is one of a span-level feature, an interpretation-level feature and a query-level feature.

5. The method of claim 3, said scoring being performed using a model, the method further comprising training the model.

6. The method of claim 5, said training the model further comprising:
obtaining training data comprising a plurality of query interpretations, each query interpretation having an associated confidence score and comprising at least one entity and entity type pair;
determining a plurality of features for each interpretation; and
training the model using the training data and the plurality of features.

7. The method of claim 6, said obtaining training data further comprising:
receiving input from a plurality of editors, the input identifying at least one interpretation for each of a plurality of queries and at least one score for each interpretation.

8. The method of claim 6, said obtaining training data further comprising:
generating at least a portion of the training data.

9. The method of claim 8, said generating at least a portion of the training data further comprising:
generating a plurality of interpretations from a plurality of queries and search results for the plurality of queries.

10. The method of claim 1, wherein the received query comprises at least one term and each interpretation comprises at least one entity and entity type pair, each entity comprising one or more terms of the query and each entity type comprising information identifying an entity category.

11. The method of claim 10, wherein the at least one confidence score comprises a score for the at least one entity and entity type pair.

12. The method of claim 1, wherein the at least one confidence score for an interpretation is a ranking relative to at least one other interpretation.

13. The method of claim 1, wherein the query comprises a numeric term, the method further comprising:
identifying an ambiguity associated with the numeric term; and
modifying the query to address the ambiguity.

14. A system comprising:
at least one server configured to:
receive a query in a web search request;
identify a plurality of interpretations of the received query, each interpretation comprising at least one confidence score;
select at least one of the plurality of interpretations of the query for use in a web search, said selecting using the at least one confidence score of each interpretation of the plurality.

15. The system of claim 14, said at least one server further configured to generate the at least one confidence score for each identified interpretation.

16. The system of claim 15, said at least one server configured to generate the at least one confidence score for each identified interpretation further configured to:
determine a plurality of features for the interpretation; and
score the interpretation using the plurality of features determined for the interpretation to generate the at least one confidence score for the interpretation.

17. The system of claim 16, wherein a feature of the plurality is one of a span-level feature, an interpretation-level feature and a query-level feature.

18. The system of claim 16, wherein the interpretation is scored using a model, said at least one server further configured to train the model.

19. The system of claim 18, said at least one server configured to train the model further configured to:
obtain training data comprising a plurality of query interpretations, each query interpretation having an associated confidence score and comprising at least one entity and entity type pair;
determine a plurality of features for each interpretation; and
train the model using the training data and the plurality of features.

20. The system of claim 19, said at least one server configured to obtain training data further configured to:
receive input from a plurality of editors, the input identifying at least one interpretation for each of a plurality of queries and at least one score for each interpretation.

21. The system of claim 19, said at least one server configured to obtain training data further configured to:
generate at least a portion of the training data.

22. The system of claim 21, said at least one server configured to generate at least a portion of the training data further configured to:
generate a plurality of interpretations from a plurality of queries and search results for the plurality of queries.

23. The system of claim 14, wherein the received query comprises at least one term and each interpretation comprises at least one entity and entity type pair, each entity comprising one or more terms of the query and each entity type comprising information identifying an entity category.

24. The system of claim 23, wherein the at least one confidence score comprises a score for the at least one entity and entity type pair.

25. The system of claim 14, wherein the at least one confidence score for an interpretation is a ranking relative to at least one other interpretation.

26. The system of claim 1, wherein the query comprises a numeric term, said at least one server further configured to:
identify an ambiguity associated with the numeric term; and
modify the query to address the ambiguity.

27. A computer-readable medium tangibly storing program code, the program code comprising:
code to receive a query in a web search request;
code to identify a plurality of interpretations of the received query, each interpretation comprising at least one confidence score;
code to select at least one of the plurality of interpretations of the query for use in a web search, said selecting using the at least one confidence score of each interpretation of the plurality.

28. The medium of claim 27, the program code further comprising code to generate the at least one confidence score for each identified interpretation.

29. The medium of claim 28, the code to generate the at least one confidence score for each identified interpretation further comprising:
code to determine a plurality of features for the interpretation; and
code to score the interpretation using the plurality of features determined for the interpretation to generate the at least one confidence score for the interpretation.

30. The medium of claim 29, wherein a feature of the plurality is one of a span-level feature, an interpretation-level feature and a query-level feature.

31. The medium of claim 29, the code to score using a model to score the interpretation, the program code further comprising code to train the model.

32. The medium of claim 31, the code to train the model further comprising:
code to obtain training data comprising a plurality of query interpretations, each query interpretation having an associated confidence score and comprising at least one entity and entity type pair;
code to determine a plurality of features for each interpretation; and
code to train the model using the training data and the plurality of features.

33. The medium of claim 32, the code to obtain training data further comprising:
code to receive input from a plurality of editors, the input identifying at least one interpretation for each of a plurality of queries and at least one score for each interpretation.

34. The medium of claim 32, the code to obtain training data further comprising:
code to generate at least a portion of the training data.

35. The medium of claim 34, the code to generate at least a portion of the training data further comprising:
code to generate a plurality of interpretations from a plurality of queries and search results for the plurality of queries.

36. The medium of claim 27, wherein the received query comprises at least one term and each interpretation comprises at least one entity and entity type pair, each entity comprising one or more terms of the query and each entity type comprising information identifying an entity category.

37. The medium of claim 36, wherein the at least one confidence score comprises a score for the at least one entity and entity type pair.

38. The medium of claim 27, wherein the at least one confidence score for an interpretation is a ranking relative to at least one other interpretation.

39. The medium of claim 27, wherein the query comprises a numeric term, the program code further comprising:
code to identify an ambiguity associated with the numeric term; and
code to modify the query to address the ambiguity.
